(19) United States
(12) Patent Application Publication
(10) Pub. No.: US 2005/0032626 A1
(43) Pub. Date: Feb. 10, 2005

(54) Reduction method of catalysts using non-thermal plasma

(75) Inventors: Hyung Keun Song, Seoul (KR); Hwaung Lee, Seoul (KR); Jae-Wook Choi, Incheon-si (KR); Gi-Seok Yang, Seoul (KR); Seung-Soo Kim, Gangwon-do (KR); Byung-Ki Na, Choongcheongbuk-do (KR)

Correspondence Address: MERCHANT & GOULD PC, P.O. BOX 2903, MINNEAPOLIS, MN, 55402-0903, US

(73) Assignee: Korea Institute of Science and Technology, Seoul (KR)

(21) Appl. No.: 10/750,487

(22) Filed: Dec. 29, 2003

(30) Foreign Application Priority Data
May 16, 2003 (KR) 10-2003-0031232

(51) Int. Cl. B01J 20/34

(52) U.S. Cl. 502/53; 600/407

(57) ABSTRACT

A method of catalysts reduction using non-thermal plasma according to the present invention is characterized to reduce catalysts containing metal compounds by bringing them into contact with hydrogen-containing gas under a non-thermal plasma state. In the method of catalysts reduction using non-thermal plasma according to the present invention, said non-thermal plasma is generated by dielectric barrier discharge. In the method of catalysts reduction using non-thermal plasma according to the present invention, the plasma energy that is required to vary depending on the types of metals is regulated by the magnitude of power via voltage regulation. In the method of catalysts reduction using non-thermal plasma according to the present invention, said reduction method is conducted in conjunction with existing methods of gaseous hydrogen reduction by heating, electrochemical reduction methods, or methods of reduction by adding organic or inorganic reducing agents.

### BACKGROUND OF THE INVENTION

1. Field of the Invention

The present invention relates to a method of reducing metal catalysts, more particularly to an economical and efficient method of reducing catalysts using non-thermal plasma instead of using conventional heating methods so that no separate heating device to make a high temperature condition is required and the time for reduction reactions is shortened.

2. Description of the Related Art

Most catalysts used in chemical reactions in current use are metal catalysts coated on catalysts carriers. These metal catalysts are produced first by dissolving precursors that are metal salts in a solvent and then coating this solution on non-metallic carriers in various ways. These catalysts undergo an oxidation process by heating at a high temperature in an oxygen atmosphere to eliminate the salt components contained in the precursors and then obtain pure metals. The catalysts undergone this oxidation process has a form that metals are carried as metal oxides, which is generally known as the form of metal catalysts.

However, to use these catalysts in reactions practically, since pure metals having the oxidation number of zero must be disposed at the surface of catalysts, they should undergo a reduction process in general. This reduction process makes the catalysts activated as catalysts and, therefore, is very important for catalysts to be used in chemical reactions.

There have been disclosed several methods of reducing catalysts; for example, a reduction method using gaseous hydrogen, a method by electrochemical reduction (WO 97/24184), or methods by adding organic or inorganic reducing agents (Korean Patent No. 150114, Korean Unexamined Patent No. 2002-094086).

In the most common reduction method, reduction reactions are conducted with hydrogen gas being flowed into a high temperature reactor, in which heat of 250 to 900° C. is required depending on the types of metals to be reduced.

However, the method of reduction at this high temperature has problems for reduction when the reactor used for chemical reactions has a structure difficult for heating or is disposed unsuitable for additional heating.

Therefore, there is required to develop a novel reduction method for catalysts, in which reduction reactions are easy to be conducted without need for a high temperature condition.

### SUMMARY OF THE INVENTION

The present invention has been made to overcome the aforementioned problems of existing methods.

An object of the invention is to provide a reduction method of catalysts using non-thermal plasma which is economical and efficient because there is no need for a separate heating device to make a high temperature condition and it is possible to shorten the reaction time for reduction by using non-thermal plasma for catalyst reduction instead of using conventional heating methods.

Another object of the invention is to provide a method of catalysts reduction using non-thermal plasma which allows a continuity between catalysts reductions and the reactions using the reduced catalysts, since the same reactor used for catalyst reduction using non-thermal plasma is used as it is.

To accomplish the above objects, the method of catalysts reduction using non-thermal plasma according to the present invention is characterized to reduce catalysts containing metal compounds by bringing them into contact with hydrogen-containing gas under a non-thermal plasma state.

In the method of catalysts reduction using non-thermal plasma according to the present invention, said non-thermal plasma is generated by dielectric barrier discharge.

In the method of catalysts reduction using non-thermal plasma according to the present invention, the plasma energy that is required to vary depending on the types of metals is regulated by the magnitude of power via voltage regulation.

In the method of catalysts reduction using non-thermal plasma according to the present invention, said reduction method is conducted in conjunction with existing methods of gaseous hydrogen reduction by heating, electrochemical reduction methods, or methods of reduction by adding organic or inorganic reducing agents.

### BRIEF DESCRIPTION OF THE DRAWING

The foregoing and other objects, features and advantages of the present invention will become more apparent from the following detailed description when taken in conjunction with the accompanying drawing in which:

FIG. 1 graphically depicts the amount of hydrogen consumptions as time elapses when metal (such as platinum and cobalt) catalysts are reduced using non-thermal plasma in accordance with the present invention.

### DETAILED DESCRIPTION OF THE INVENTION

Carrier metal catalysts are generally produced by methods of precipitation or impregnation, in which the carriers are coated uniformly with a metal precursor solution. The catalysts so obtained are put in the processes of oxidation and reduction to leave pure metal components. However, if a metal compound itself functions as catalyst, it can be put only in the oxidation process.

The oxidation process is a process in which impurities contained in the metal precursors are eliminated by maintaining them at high temperatures in an oxygen or air atmosphere so that the surfaces of catalysts are made pure metal compounds. Catalysts finished up to this process are stored or circulated as they are, and are put in the reduction process just before the actual use.

The reduction process is a process in which catalyst surfaces being metal oxides are to be substituted by pure metals to make metal catalysts activated. In the reduction process hydrogen is used. When hydrogen is flowed over in a high temperature condition, oxygen adhered to metal oxides on the catalyst surface reacts with hydrogen to make water so that pure metals are left. The temperature condition required for reduction of metal catalysts depends on the types of the metals. The reduction temperature suitable for a given metal is usually determined via a temperature programmed reduction (TPR) test.

In the present invention, metal catalysts are reduced using plasma energy instead of using this thermal energy caused by high temperatures.

The plasma state is called the fourth state different from solid, liquid, and gas states. Plasma comprises molecules, atoms, ions (of ground state or excited state), electrons, and protons, and is in electrically neutral state known as quasi-neutral as a whole.

Plasma is classified into thermal plasma (equilibrium plasma) and non-thermal plasma (non-equilibrium plasma). Thermal plasma inducing temperatures higher than 1000° C. is used in the fields like arc welding.

The non-thermal plasma used in the present invention is plasma of near room temperature having a low degree of ionization. This plasma can be implemented by maintaining electrons at high temperatures of 10,000 K to 100,000 K whilst the plasma temperature is kept low (from room temperature to 1,000K) using specific discharge systems. Examples of non-thermal plasmas include Dielectric Barrier Discharge (DBD), corona discharge, microwave discharge, and arc discharge.

Corona discharge can be implemented most easily, but is applied for extremely limited purposes due to its low energy density. In some cases of reducing catalysts using corona discharge, there may need to provide some additional heat.

Microwave discharge allows relatively high energy and heat of high temperatures, but the installation is expensive and requires a relatively high operational cost.

Dielectric barrier discharge is a technique that gives birth to discharges using a reactor which is structured to shield electrodes with a dielectric substance. In this reactor, uniform glow discharge is obtained by maximizing the efficiency of the voltage applied by an alternate current source utilizing the charge build-up phenomenon of dielectrics. In this technique, the radical concentration is 100 to 1000 times higher than in existing vacuum plasma and the temperature is as low as room temperature to 150° C.

As a typical example of the dielectric barrier discharge generator, there has been proposed a coaxial type generator in which metal electrodes such as stainless steel are concentrically disposed inner and outer positions and a glass or ceramic dielectric is disposed there between (Korean Unexamined Patent No. 2001-0005441, Korean Unexamined Patent No. 2000-0030121, Korean Unexamined Patent No. 1999-0031892, Korean Unexamined Patent No. 1998-081118). Another example of dielectric barrier discharge generators in common use is a contact type generator. In fabricating this generator, a metal film is coated on or a metal plate is brought into contact with the outer surface of a dielectric such as glass, and a metal wire coil is inserted inside the dielectric tube in a tightly fit manner so that two electrodes are in contact with the dielectric there between (Korean Unexamined Patent No. 2001-0015789, Korean Unexamined Patent No. 2000-0061577, Korean Unexamined Patent No. 2000-0058938, Korean Unexamined Patent No. 2000-0058453, Korean Unexamined Patent No. 1999-0068473, Korean Unexamined Patent No. 2000-0046786).

Although the present invention can use any type of non-thermal plasma, the dielectric barrier discharge using dielectric is most suitable.

While the reduction temperature is varied depending on the types of metals in case of reducing catalysts using the conventional heating method, the temperature in the present invention is regulated by the consumption power via regulating the plasma generation voltage.

General methods of producing catalysts can explained as follows by taking the incipient wetness method as an example.

First, a metallic salt is dissolved in a distilled water of which volume corresponds to the microporous volume(cc/g) of carriers. Then, the metal salt solution is dropped drop by drop onto the carriers as much as the microporous volume(cc/g) of carriers and is stirred well so as to be soaked well into the interior of the carrier particles. Then, the moisture is eliminated by maintaining them in an oven at temperatures higher than 120° C. for a certain period of time. And, the catalysts are calcined at temperatures higher than 400° C. in an oxygen atmosphere.

In the present invention, the catalyst so produced are put inside a plasma reactor, and then reduced by generating plasma while hydrogen mixed with nitrogen by volume ratio of 5% to 30% is flowed into the dielectric barrier discharge reactor.

The present method is economical compared with the conventional methods, since the power consumed for plasma generation is 40 to 85% of that of conventional reduction methods by heating. Although any power source which can generate plasma can be usable as a power source for the present invention, high-frequency alternate current or high frequency pulse generators, especially high-frequency anode DC pulse generators, are most efficient considering the energy and economic efficiency.

As a certain period of time elapsed, catalysts reduction is completed inside the reactor. If the catalysts are exposed to the air after reduction, since some of catalyst surfaces are slightly oxidized, the catalyst activity is lost. Therefore, it is desirable for reduced catalysts not to be exposed to the air. Therefore, it is more efficient to induce plasma chemical reactions by passing reactants directly over the reduced catalysts using non-thermal plasma in accordance with the present invention.

The catalyst reduction method using non-thermal plasma according to the present invention can shorten the time required for reduction reactions. In other words, in cases of utilizing the existing heating methods, it takes a certain period of time for heating up the reactor and more than two hours at high temperatures are required after start of the reduction reactions. However, since the reduction process starts right away without requiring time for heating the reactor and almost all of catalysts are finished with reduction within an hour in the present invention, the whole catalysts reduction process can be completed far more rapidly.

Hereinafter, the present invention will now be described in more detail with reference to the following Embodiments and Preparative Embodiments. However, these embodiments are given by way of illustration and not of limitation.

### EMBODIMENT 1

1 wt % Pt/γ(gamma)-Al₂O₃ catalyst was produced by an incipient wetness method using carriers of alumina and precursor of H₂PtCl₆.6H₂O. Then 1 g of the catalyst was filled into the bottom of a cylinder-wire type dielectric barrier discharge reactor having an interior volume of 10 cc. Then, while hydrogen and nitrogen mixed by volume ratio of 1:4 was being flowed into the dielectric barrier discharge reactor, non-thermal plasma was generated. Reduction reactions progress as hydrogen molecules activated by plasma combine with oxygen atoms on the surface of metal oxide catalysts carried by alumina to form water.

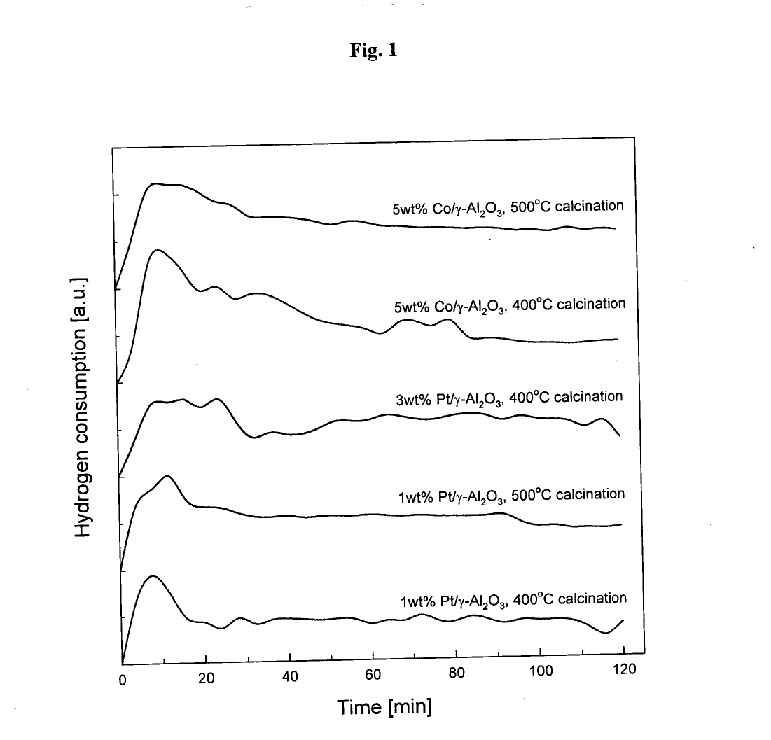

FIG. 1 shows the amount of hydrogen consumptions as time elapses when metal (such as platinum and cobalt) catalysts are reduced using non-thermal plasma in accordance with the present invention. As shown in FIG. 1, hydrogen is consumed rapidly at the initial stage of reactions and the reduction of platinum catalysts is almost complete within 40 minutes.

To check the reactivity of the catalysts reduced using non-thermal plasma in accordance with the present invention, a methane conversion test was conducted.

In comparative example 1, 1 wt % Pt/γ-Al₂O₃ catalyst was produced by the incipient wetness method and calcined at temperatures of 400° C. and 500° C. in oxygen atmosphere and reduced while hydrogen and nitrogen gases were being flowed into a reactor at temperature of 400° C. On the other hand, in embodiment 1, catalysts were reduced using non-thermal plasma. For both the catalysts of comparative example 1 and embodiment 1, methane conversion reactions utilizing plasma were conducted in a dielectric barrier discharge reactor and then the reaction conversion ratio and the selectivity of the products were measured. Table 1 shows the results comparing the reaction conversion ratios and the selectivities of the products between comparative example 1 and embodiment 1. Here, the flow rate of methane being used as reactant was 30 ml/min and the voltage used for plasma reduction was 3 kV. Reaction conversion ratio is the ratio of amounts between the consumed methane and the input methane. And, selectivity is the ratio of amounts between the produced products and the converted methane.

TABLE 1

| | | 1 wt % Pt/ [symbol] -Al₂O₃ | | | |
|---|---|---|---|---|---|
| | | Reaction Experiment after | | Reaction Experiment | |
| | | Reduction for | | after Plasma | |
| | | 2 hours at 400° C. | | Reduction | |
| | | 400° C. | 500° C. | 400° C. | 500° C. |
| | | Calcination | Calcination | Calcination | Calcination |
| Methane | | 30.62 | 25.94 | 36.41 | 33.25 |
| Conversion | | | | | |
| Ratio[%] | | | | | |
| Se- | C₂H₂ | — | 0.87 | 0.51 | 0.48 |
| lec- | C₂H₄ | 0.31 | 1.53 | 1.25 | 1.23 |
| tivity | C₂H₆ | 30.87 | 39.95 | 36.96 | 37.62 |
| [%] | C₃H₆ | 0.14 | 0.80 | 1.59 | 2.39 |
| | C₃H₈ | 15.23 | 13.68 | 16.01 | 15.86 |
| | C₄H₁₀ | 11.21 | 7.27 | 8.29 | 8.28 |

As shown in Table 1, when catalysts are reduced using non-thermal plasma in accordance with the present invention, the methane reaction conversion ratio is ascertained to be slightly higher than in other cases. And, it is also ascertained there is almost no difference in the selectivity of reaction products between the catalysts reduced at high temperatures and the catalysts reduced using non-thermal plasma.

Platinum catalysts reduced while hydrogen and nitrogen gases being flowed into a reactor at 400° C. (Comparative example) and platinum catalysts reduced using non-thermal plasma(Embodiment) were applied to general heating reactions, not plasma reactions. The results of this comparative experiment are shown in Table 2. Here, the reaction temperature was maintained at 650° C. using an electric reactor.

TABLE 2

| | | 1 wt % Pt/ [symbol] -Al₂O₃, 400° C. Calcination | |
|---|---|---|---|
| | | Reaction Experiment | |
| | | at 650° C. | Reaction Experiment |
| | | after Reduction for 2 hours | at 650° C. |
| | | at 400° C. | after Plasma Reduction |
| Methane Conversion | | 32.48 | 31.40 |
| Ratio [%] | | | |
| Selectivity | C₂H₂ | — | — |
| [%] | C₂H₄ | 0.89 | 0.42 |
| | C₂H₆ | 1.25 | 0.44 |
| | C₃H₆ | 0.08 | 0.02 |
| | C₃H₈ | 0.05 | 0.01 |
| | C₄H₁₀ | 0.91 | 1.16 |

As shown in Table 2, the reaction conversion ratio is almost the same for the catalysts reduced by heating and the catalysts reduced using non-thermal plasma. Therefore, it is ascertained from the above results that catalysts can be reduced excellently by non-thermal plasma.

From the results of tables 1 and 2, the catalysts reduced using non-thermal plasma according to the present invention is ascertained to be equally applicable to general reactions as well as plasma reactions.

In the reduction using non-thermal plasma in accordance with the present invention, the reduction began concurrently with plasma generation and lasted for two hours. The power used for the reduction was 64 W, which is equivalent to 468 kJ when converted in energy supplied for 2 hours. On the other hand, in case of reduction by heating method, the reactor was heated up to 400° C. or 500° C. using a heater as a first stage, and then reduction reactions were conducted for 2 hours with gas being flowed in. The power used for these reactions, counting in only the period of reduction process, is 455 kJ for the reduction at 400° C. and 584 kJ for the reduction at 500° C., respectively. However, counting in the energy consumed for heating to 400° C. or 500° C. before start of the reduction reactions, the energy supplied for the whole reduction process amounts to 775 kJ for the reduction at 400° C. and 1042 kJ for the reduction at 500° C., respectively. In other words, the energy consumed for catalyst reduction using non-thermal plasma in accordance with the present invention is equivalent to just 62% of that for reduction at 400° C. and 45% of that for reduction at 500° C.

### EMBODIMENT 2

5 wt % Co/γ-Al₂O₃ catalyst was produced by an incipient wetness method using carriers of alumina and precursor of Co(NO₃)₂.6H₂O. Then 1 g of the catalyst was filled into the bottom of a cylinder-wire type dielectric barrier discharge reactor having an interior volume of 10 cc. Then, while hydrogen and nitrogen mixed by volume ratio of 1:4 were being flowed into the dielectric barrier discharge reactor, non-thermal plasma was generated. Reduction reactions progress as hydrogen molecules activated by plasma combine with oxygen atoms on the surface of metal oxide catalysts carried by alumina to form water.

FIG. 1 shows the amount of hydrogen consumptions as time elapses when metal (such as platinum and cobalt) catalysts are reduced using non-thermal plasma in accordance with the present invention. As shown in FIG. 1, hydrogen is consumed rapidly at the initial stage of reactions and the reduction of platinum catalysts is almost complete within 60 minutes.

To check the reactivity of the cobalt catalysts reduced using non-thermal plasma in accordance with this embodiment, a methane conversion test was performed.

In comparative example 2, 5 wt % Co/γ-Al₂O₃ catalyst was produced by the incipient wetness method and calcined at temperatures of 400° C. and 500° C. in oxygen atmosphere and reduced at temperature of 400° C. On the other hand, in embodiment 2, catalysts were reduced using non-thermal plasma. For both the catalysts of comparative example 2 and embodiment 2, methane conversion reactions utilizing plasma were conducted in a dielectric barrier discharge reactor and then the reaction conversion ratio and the selectivity of the products were measured. Table 2 shows the results comparing the reaction conversion ratios and the selectivities of the products between comparative example 2 and embodiment 2. Here, the flow rate of methane being used as reactant was 30 ml/min and the voltage used for plasma reduction was 3.3 kV.

TABLE 3

| | | 5 wt % Pt/ [symbol] -Al₂O₃ | | | |
|---|---|---|---|---|---|
| | | Reaction Experiment after | | Reaction Experiment | |
| | | Reduction for | | after Plasma | |
| | | 2 hours at 400° C. | | Reduction | |
| | | 400° C. | 500° C. | 400° C. | 500° C. |
| | | Calcination | Calcination | Calcination | Calcination |
| Methane | | 38.78 | 38.69 | 36.69 | 31.52 |
| Conversion | | | | | |
| Ratio [%] | | | | | |
| Se- | C₂H₂ | 0.88 | 3.19 | 0.58 | 1.53 |
| lec- | C₂H₄ | 2.46 | 2.29 | 2.02 | 1.99 |
| tivity | C₂H₆ | 21.31 | 20.01 | 28.30 | 25.69 |
| [%] | C₃H₆ | 1.07 | 1.35 | 0.84 | 1.31 |
| | C₃H₈ | 10.23 | 9.03 | 16.58 | 13.51 |
| | C₄H₁₀ | 5.32 | 5.40 | 7.21 | 5.32 |

As shown in table 3, the reaction conversion ratio is almost equivalent for the catalysts reduced by heating and the catalysts reduced using non-thermal plasma. Although, the reaction conversion ratio of catalysts calcined at 500° C. in embodiment 2 was slightly decreased, the selectivity for ethane and propane was ascertained to be improved as compared with the catalysts reduced at high temperatures.

The power used for reducing the cobalt catalysts for two hours using non-thermal plasma was 101 W, which is equivalent to 634 kJ when converted in energy. On the other hand, in case of reduction by a heating method, counting in the energy consumed for heating the reactor temperature up to 400° C. or 500° C. before the start of the reduction reactions, the consumed power used for these reactions is 775 kJ for the reductions at 400° C. and 1042 kJ for the reduction at 500° C., respectively. In other words, the energy consumed for cobalt catalyst reduction using non-thermal plasma in accordance with the present invention is equivalent to just 82% of that for reduction at 400° C. and 61% of that for reduction at 500°.

From the above results, it is found that metal catalysts, regardless of the types of metals, can be excellently reduced by the catalyst reduction method using non-thermal plasma in accordance with the present invention.

As explained above, since the catalyst reduction method using non-thermal plasma in accordance with the present invention uses non-thermal plasma instead of using the existing heating method for catalyst reduction, a separate heating device is not needed for making a high temperature condition and the time required for reduction reactions is shortened so that said method is economical.

The existing catalysts reduction method consumes much energy for reduction because heating is required to the temperatures higher than about 400° C. However, the present method can save energy needed for catalyst reduction.

Also, in case of catalysts reduction in accordance with the present invention, the reduction efficiency for catalysts is excellent so that the reactivity of the catalysts is comparable or even superior to the existing heating method.

In the catalyst reduction method using non-thermal plasma in accordance with the present invention, reduction of catalysts and reactions using the reduced catalysts can be conducted continuously by using the same non-thermal plasma reactor used for catalysts reduction as it is. In addition, the catalysts reduced according to the present invention are applicable to existing chemical reactors in general use.

Also, the present invention can be used in conjunction with existing reduction methods so that it allows to widen the choices for conditions of reduction reactions.

1. A method of catalysts reduction using non-thermal plasma in which catalysts containing metal compounds are reduced by bringing them into contact with hydrogen-containing gas under a non-thermal plasma state.

2. The method as in claim 1, wherein said non-thermal plasma is generated by dielectric barrier discharge.

3. The method as in claim 1, wherein the plasma energy that is required to vary depending on the types of metals is regulated by the magnitude of power via voltage regulation.

4. The method as in claim 2, wherein the plasma energy that is required to vary depending on the types of metals is regulated by the magnitude of power via voltage regulation.

5. The method as in claim 1, wherein said reduction method is conducted in conjunction with existing methods of gaseous hydrogen reduction by heating, electrochemical reduction methods, or methods of reduction by adding organic or inorganic reducing agents.

6. The method as in claim 2, wherein said reduction method is conducted in conjunction with existing methods of gaseous hydrogen reduction by heating, electrochemical reduction methods, or methods of reduction by adding organic or inorganic reducing agents.
